(19) United States
(12) Patent Application Publication
(10) Pub. No.: US 2006/0280181 A1
(43) Pub. Date: Dec. 14, 2006

(54) Systems and methods for operating and management of RFID network devices

(75) Inventors: Nicholas M. Brailas, San Jose, CA (US); Brian J. Kindle, Sunnyvale, CA (US); Amir Sharif-Homayoun, Fremont, CA (US); William G. Rivard, Menlo Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ripcord Technologies, Inc. (a Delaware Corporation), Fremont, CA (US)

(21) Appl. No.: 11/436,290

(22) Filed: May 17, 2006

Related U.S. Application Data
(60) Provisional application No. 60/682,193, filed on May 17, 2005.

(51) Int. Cl. H04L 12/56

(52) U.S. Cl. 370/392; 340/572.1

(57) ABSTRACT

Systems and methods for improving the performance of data collection networks. Such systems are provided for conditioning and aggregating data from data collection elements and provided for presenting this aggregated data through a common interface. Also included are means for data collection and retention in successive hierarchical proxy levels, providing device aggregation.

### CROSS-REFERENCES TO RELATED APPLICATIONS

This present application claims priority to U.S. Provisional Application No. 60/682,193, titled “Systems and Methods for Operating and Management of RFID Network Devices,” filed May 17, 2005, commonly assigned, and hereby incorporated by reference for all purposes.

### BACKGROUND OF THE INVENTION

The present invention relates generally to data processing techniques. More particularly, the present invention provides methods and systems for a distributed data collection, aggregation, conditioning, processing, formatting, forwarding, and partitioning, among other features. In a preferred embodiment, the present methods and systems are provided to gather, retain, forward, format, pre-process, and present data to one or more applications that process that data. As merely an example, such applications include, among others, collecting information from radio frequency identification tags, commonly called RFID tags, which are used as identification tags. But it would be recognized that the invention has a much broader range of applicability. For example, the invention can be applied to almost any types of information collection devices where large quantities of information are desirably processed.

Over the years, we have improved ways of tracking objects such as automobiles, merchandise, and other physical entities. As merely an example, item identification tags have been in commercial use for a long time. Printed optical tags, such as the Universal Product Code (UPC) standard, appear as high contrast stripes or 2 dimensional patch patterns on the tagged object. A UPC tag is present on most retail products and appears as a familiar black and white barcode. Although highly successful, UPC tags have certain limitations. That is, such tags have limited information. Additionally, such tags cannot be broadly used for certain applications. These limitations will be described in more detail throughout the present specification and more particularly below.

Accordingly, Radio Frequency Identification (RFID) tag technologies have been introduced. RFID tags represent a relatively new form of item identification tagging. The proposed Electronic Product Code (EPC) standard is an example of an RFID-based equivalent to the optical UPC standard. Both optical tags and RFID tags allow a reader device to retrieve information from a tagged item; however, there are significant practical differences between the two approaches.

With UPC, the tag reader device must have unobstructed line of sight access to the tag. Furthermore, the UPC tags must often be presented to the reader to be scanned. FIG. 1 illustrates the read path of an optical tag reader 100. An optical subsystem 101 emits a focused scanning beam 102 on a presented tag 103 associated with an item to be scanned 105. The scanned tag 103 reflects an optical signal 104 in response to the scanning beam 102. The tag reader 100 then reports the recently read tag information to an upstream data management system 108. If item 105 is constructed from an opaque material, such as a cardboard or wood, then an enclosed item such as 107 is not readable because its tag 106 is not visible to the reader 100.

An RFID tag reader uses radio frequency energy to read the tags and can therefore access a large number of tags in a given area irrespective of visual access. FIG. 2 illustrates the RFID read path of an RFID reader 200. An RF antenna system 201 emits a read indicator signal 202 to all tags within its range including 203 and 206. With the EPC standard, this read indicator signal 202 includes both the energy to activate all tags within its RF range and instructions to each individual tag to help the tag reader 200 uniquely identify all tags within RF range. The read indicator signal 202 can penetrate most packaging materials such as cardboard, wood and plastic, making all enclosed tags visible from an RF standpoint. Thus, a tag 203 attached to an enclosing carton 205 is visible to the reader 200 along with all enclosed tags such as 206. Therefore, the reader can detect individual items 207 in a carton 205. When queried by a read indicator signal 202, each RFID tag will respond to the reader 200 with its own response 204, 209, 210. The reader 200 reports gathered tag information to an upstream data management system 208.

Historically, tagging systems have been limited in scope and capacity to applications enabled by optical tags. These applications generated only modest quantities of data because they were naturally limited by the physical presentation rate of tags to optical readers.

With RFID tags, an individual item need not be physically maneuvered in front of a reader to be read. RFID tagged items may be read in any mix of loose, packaged or multiply packaged (cartons within cartons) configurations so long as the RF energy from the reader can penetrate the packaging and the reply signal can sufficiently exit the packaging material and reach the reader. Tagged items or boxes of tagged items may be in motion in shipping and receiving bays or at inventory control points; they may also be sitting still in shelves or storage areas. In all cases, the RFID tags are being constantly read by their corresponding tag reader. Items in motion may require much more aggressive read rates to avoid missing one or more of the tagged items as they pass by the reader; this would be the case in a receiving bay with a conveyor belt for incoming tagged items.

The ability to constantly take inventory is a key component to efficient material management and shrinkage reduction in retail stock management, supply chain management, manufacturing, material storage and other applications. It is therefore advantageous for an RFID reader to be constantly querying all of its tags under management. Unfortunately, RFID systems have certain limitations. That is, present networking systems have not been adapted to effectively process information from the RFID readers when large quantities of information are to be monitored. These and other limitations are described throughout the present specification and more particularly below.

From the above, it is seen that techniques for improving information processing of large quantities data are highly desirable.

### BRIEF SUMMARY OF THE INVENTION

According to the present invention, techniques related generally to data processing are provided. More particularly, the present invention provides methods and systems for a distributed data collection, aggregation, conditioning, processing, formatting, forwarding, and partitioning, among other features. In a preferred embodiment, the present methods and systems are provided to gather, retain, forward, format, pre-process, and present data to one or more applications that process that data. As merely an example, such applications include, among others, collecting information from radio frequency identification tags, commonly called RFID tags, which are used as identification tags. But it would be recognized that the invention has a much broader range of applicability. For example, the invention can be applied to almost any types of information collection devices where large quantities of information are desirably processed.

In a specific embodiment, the present invention provides a method for managing a plurality of objects using RFID tags in a real-time environment. The method includes transferring information in a first format from one or more RFID tags using an RFID network. In a specific embodiment, the one or more RFID tags is coupled to respective objects, which is often capable of movement by a human user. The method includes capturing information in the first format using one or more RFID readers provided at one or more predetermined spatial region using the RFID network and parsing the information in the first format into a second format. The method includes processing the information in the second format using one or more processing rules to identify if the one or more RFID tags at a time period of T1 is associated with the one or more RFID tags at a time period of T2. The method transfers a portion of the information from the RFID network to an enterprise network. The method also receives the portion of the information at an enterprise resource planning process using the enterprise network. The method also includes determining if the one or more respective objects is physically present at a determined spatial location or not present at the determined spatial location at the time period T2.

In an alternative specific embodiment, the present invention provides an alternative method for processing RFID traffic between a first network and a second network. The method transfers information associated with a plurality of RFID tags corresponding to respective plurality of objects in a first format through an RFID network. The method also includes processing the information in the first format using one or more rules to identify one or more attributes in a portion of the information in the first format. Depending upon the embodiment, the one or more attributes in the portion of the information is associated with at least one of the plurality of RFID tags. The method includes processing the portion of the information in the first format associated with the change into information in a second format to be transferred from the RFID network. The method transfers the portion of the information in the second format through an enterprise network. In a preferred embodiment, the method includes dropping other information in the first format from being transferred through the enterprise network to reduce a possibility of congestion through the enterprise network.

In yet an alternative specific embodiment, the present invention provides a system for managing RFID devices operably disposed in a pre-selected geographic region. The system has at least 3 RFID readers. Each of the RFID readers is spatially disposed in selected determined regions of a physical space. An RFID network is coupled to each of the RFID 5 readers. An RFID gateway is coupled to the RFID network. The RFID gateway is adapted to process information in at least a link layer and a network layer of the RFID network from the at least 3 RFID readers. The system has an enterprise network coupled to the RFID gateway; and an ERP (Enterprise Resource Planning Software) management process coupled to the enterprise network and coupled to the RFID gateway.

In a specific embodiment, the present RFID gateway avails its state to one or more upstream RFID gateways or data processing applications. Depending upon the embodiment, the present RFID gateway can be combined with network switching elements. Additionally, two or more RFID gateways can be formed into an encapsulation proxy/hierarchy to further reduce network traffic load. Two or more RFID gateways can also be formed into an encapsulation proxy/hierarchy to further reduce gateway computation load. Two or more RFID gateways can be formed into an encapsulation proxy/hierarchy to further improve device management.

Certain advantages and/or benefits may be achieved using the present invention. The present methods and systems can be implemented using conventional computer software, firmware, and combinations of hardware according to a specific embodiment. In a preferred embodiment, the present methods and systems overcome certain limitations of processing large quantities of information that have plagued conventional techniques. Depending upon the embodiment, one or more of these benefits may be achieved. These and other benefits will be described in more throughout the present specification and more particularly below.

Other features and advantages of the invention will become apparent through the following detailed description, the drawings, and the claims.

### BRIEF DESCRIPTION OF THE DRAWINGS

FIG. 1 illustrates a conventional process of reading optical tag.

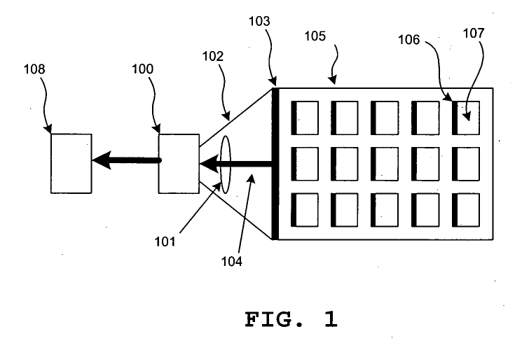

FIG. 2 illustrates a conventional process of reading RFID tag.

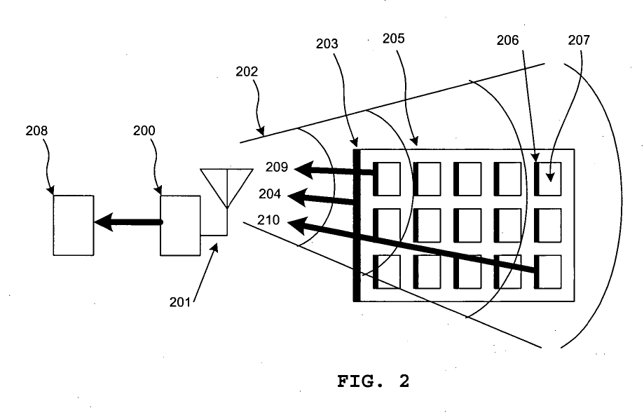

FIG. 3 illustrates a conventional data collection network with Data Collection Elements, Network Switches and Compute Servers.

FIG. 4 illustrates a data collection network with the addition of a Data Proxy Network and Data Aggregation Gateway according to an embodiment of the present invention.

FIG. 4A illustrates a typical shelving unit with RFID readers providing volumetric coverage of shelved items according to an embodiment of the present invention.

FIG. 4B illustrates a data collection network infrastructure deployed in a retail space, with RFID readers providing tag coverage within the shelving unit floor space, a standard Ethernet switch network and a Data Aggregation Gateway according to an embodiment of the present invention.

FIG. 5 illustrates the process of consolidating data packets into fewer, larger packets for better network utilization and lower computational overhead according to an embodiment of the present invention.

FIG. 6 shows the redundant characteristic of certain common types of data collection networks according to an embodiment of the present invention.

FIG. 7 shows the non-redundant information from FIG. 6 according to an embodiment of the present invention.

FIG. 8 illustrates a basic application of the Data Aggregation Gateway for applications where transparent presentation of tag reader data is required according to an embodiment of the present invention.

FIG. 9 illustrates time and bandwidth scale significance in different areas of a supply chain management system according to an embodiment of the present invention.

FIG. 10 illustrates the downstream management of index references according to an embodiment of the present invention.

FIG. 11 illustrates index encapsulation by downstream Data Aggregation Gateways according to an embodiment of the present invention.

FIG. 12 shows the key agents and data flow in a Data Aggregation Gateway according to an embodiment of the present invention.

FIG. 13 illustrates the packet classification process according to an embodiment of the present invention.

FIG. 14 illustrates the Tag ID lookup process resulting in a database entry index according to an embodiment of the present invention.

FIG. 15 illustrates the concept of a Private Collection Network versus a Public Collection Network, with the Data Aggregation Gateway being the demarcation point bridging the two according to an embodiment of the present invention.

FIG. 16 shows a multi-stage network of Data Aggregation Gateways, collectively presenting a single aggregated view of the Data Collection Elements according to an embodiment of the present invention.

FIG. 17 illustrates the concept of providing multiple views of the same Collector data according to an embodiment of the present invention.

FIG. 18 illustrates an exemplary software architecture for the Data Aggregation Gateway system according to an embodiment of the present invention.

### DETAILED DESCRIPTION OF THE INVENTION

According to the present invention, techniques related generally to data processing are provided. More particularly, the present invention provides methods and systems for a distributed data collection, aggregation, conditioning, processing, formatting, forwarding, and partitioning, among other features. In a preferred embodiment, the present methods and systems are provided to gather, retain, forward, format, pre-process, and present data to one or more applications that process that data. As merely an example, such applications include, among others, collecting information from radio frequency identification tags, commonly called RFID tags, which are used as identification tags. But it would be recognized that the invention has a much broader range of applicability. For example, the invention can be applied to almost any types of information collection devices where large quantities of information are desirably processed.

It is to be understood that the present invention may be implemented in various forms of hardware, software, firmware, special purpose processors, or combinations thereof.

We have discovered that an amount of generated data can quickly mount to reduce an efficiency of an RFID network. For example, large discount retail chains may have many millions of items on the floor in each retail space; they may receive thousands of cartons a day and sell tens of thousands of items a day. With a comprehensive RFID inventory tracking system in place and the entire inventory scanned completely in a very short time (minutes or seconds), the amount of raw data generated by the scanning process is enormous—potentially tens of gigabytes per minute per site.

Processing tens of gigabytes of transactional data per minute often exceeds the capacity of most compute servers and the network infrastructure of most existing enterprises. These performance limitations limit the usefulness and feasibility of current reader-based solutions. Furthermore, there are potentially two categories of tag data read scenarios: the first is the constant background reading conducted by all readers to periodically yield a comprehensive inventory. You would find this type of scenario in a retail store. The second is very high peak rate data. In settings such as warehouses, manufacturing plants, and large retail sites, inventory arrives in peaks and potentially leaves in peaks. In manufacturing settings, where items are manufactured at an even pace but leave the site in larger groups (in containers, boxes or crates), data rate peaks occur at the outgoing shipping bay.

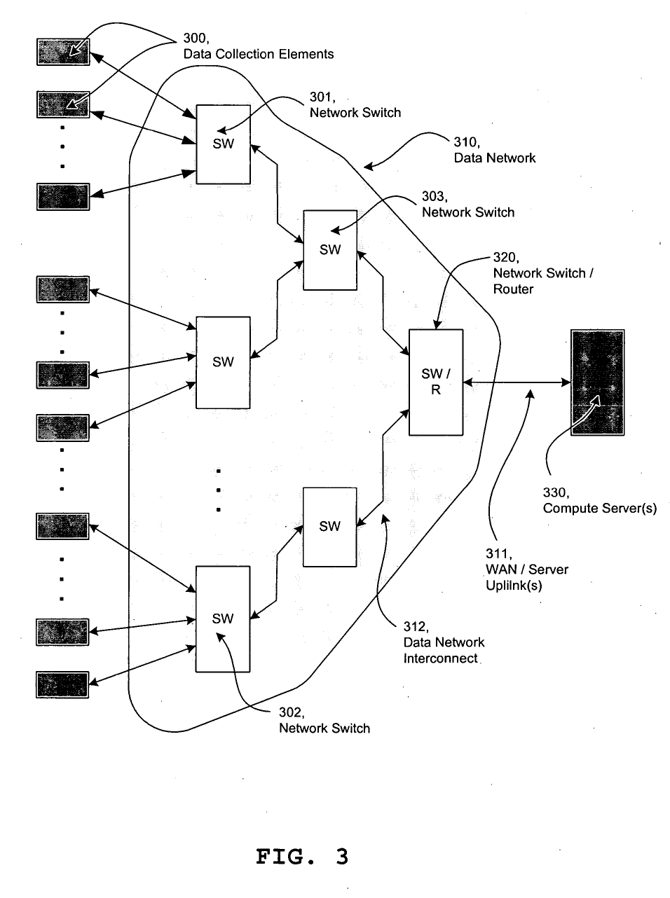

FIG. 3 illustrates a data collection network. A set of Data Collection Elements 300 is connected to one or more Network Switches (marked “SW” in FIG. 3) 301, 302, 303 that form a data network 310; this Data Network 310 connects the Data Collection Elements 300 to the Computer Server(s) 330, where the collected data is processed. In FIG. 3, the Data Collection Elements 300 could be, for example, optical tag readers 100, RFID tag readers 200, or a mix of both and potentially other types of data collection and sensing devices. An arbitrarily large number of Data Collection Elements 300 may exist or may be added to a data collection system, generating an arbitrarily large volume of data per unit time. Network Switches 301, 302, 303 and Data Network Interconnects 312 form a Data Network 310 that is able to aggregate an arbitrarily large amount of data from the Data Collection Elements 300.

Within a given generation of network technology, Data Network Interconnects 312 and the switch ports that accommodate them have a certain cost per megabit/second of bandwidth for a given port bit rate. For example, an Ethernet LAN port may be capable of 10, 100, 1000 or 10,000 megabits/second port with a cost structure favoring lower bit rates and copper-based interconnects over fiber-based interconnects. Within a given generation of network technology, there is a fixed and maximum date rate that can be feasibly built. Ethernet, for example has gone through 4 popular generations to date of maximum data rates, starting with 10 megabits/second and going to 100 Mbps, 1 Gbps, and then 10 Gbps.

Similarly, WAN/Server Uplinks 311 have a certain cost per megabit/second of bandwidth in a given generation of WAN technology, which is typically many orders of magnitude more expensive to operate for a given bandwidth. If Compute Servers 330 are not physically co-located with the Data Network 310, then the uplink cost can be prohibitive. But even taking cost out of consideration, the aggregate raw bandwidth from a collection of Data Collection Elements 300 can easily exceed the maximum available speed of a WAN uplink in certain geographies.

In many cases, a router is needed between LAN and WAN facing interfaces; FIG. 3 labels this function a Network Switch Router 320.

The Compute Server 330 does not scale very easily and must be co-located with the Data Network 310 if the peak aggregated bandwidth of the Data Network 310 exceeds the WAN/Server Uplink 311 bandwidth. Co-locating servers with the data collection network is the current trend and is the solution proposed by name brand server vendors to date.

Tag readers in a given network can grow arbitrarily large in number and create large volumes of data, heavily loading (or overloading) the network and compute infrastructure. The sheer volume of data creates a situation where conventional data processing architectures break down, creating “data smog”: huge volumes of data, without the ability to process that data in any meaningful way or extract any meaningful actionable information from the data.

Configuring large reader deployments can be problematic; each reader must be configured and associated with its collection region. This information must be conveyed upstream to higher-level applications for various operational purposes, such as locating an errant box of breakfast cereal in the motor oil department or sending a service technician to a malfunctioning reader. This configuration work can be done manually, but like all manual processes, it is both expensive and prone to human error. With potentially hundreds or thousands of readers in a single site, with some being added or removed dynamically, the opportunity for human error is significant.

RFID deployments currently suffer from trying to cope with more data than existing architectures can cost effectively process, leaving the system in a constant data smog. Conventional data processing architectures do not scale well to solve this problem. Current solutions involve throwing large amounts of expensive compute power at the problem in an attempt to provide the appropriate level of processing power. The high deployment cost associated with processing the enormous volumes of data in a practical setting is impeding widespread adoption of RFID tagging, despite significant progress in other areas of the RFID data technology pipeline.

Another similar “data smog” situation exists with large industrial plants. Enormous volumes of real time (i.e., time critical) data are generated in oil platforms, chemical processing plants, and manufacturing lines. One strategy for managing the mix of critical and less-critical data is to segregate the collection process into multiple levels of criticality; but this approach serves to undermine the frequent need to integrate various levels of data criticality in unified feedback control and decision support systems. In practice, data processing in these large industrial plant sensor networks is performed at lower than desirable levels because of practical limits in the network infrastructure and compute server architecture.

Wireless sensor networks are yet another type of system where conventional data processing architectures are inadequate for potentially two reasons. This type of sensor network consists of a potentially large number of independently operating devices that connect via some wireless means (optical laser, direct RF links, ad-hoc network, etc.) to one or more data processing applications. In ad-hoc sensor networks there are potentially a large number of hops between a sensor and an application that receives data from the system's sensors. Latency and peak throughput are the defining characteristics of these types of networks. When a query is sent to one of the member network nodes, the ad-hoc network provides connectivity for the request; the ad-hoc network's latency and peak throughput determine how long the query takes to be serviced. Alternately, if the ad-hoc network has many wired access points there is a potential for the sensor network to inject significant amounts of data into the wired portion of the network overwhelming traditional data processing architectures. This is a similar situation to the RFID and industrial plant data smog situation in that a large number of independent devices are trying to push data through a large number of pipes, through some aggregation network, to a compute server that is ill equipped to deal with the arbitrarily high volume of data.

Thus, there are numerous applications that utilize general-purpose components such as network switches and compute servers to define their system architectures. Conventional architectures built using conventional systems elements do not scale very well because they attempt to handle larger than convenient volumes of application specific data with general-purpose strategies. Applying general-purpose strategies to very specific problems is historically the first and fastest way to a solution, but is infrequently the optimal solution. New, rapidly growing applications in the RFID and sensor networks spaces are already stressing general-purpose solutions well beyond their cost effective limits today.

In a specific embodiment, the present invention introduces a system element and system architecture for high throughput data gathering and data aggregation, device aggregation and device management processing systems. Depending upon the embodiment, certain limitations in the prior art are overcome through novel architectural and algorithmic efficiency. Further details of the present invention can be found throughout the present specification and more particularly below.

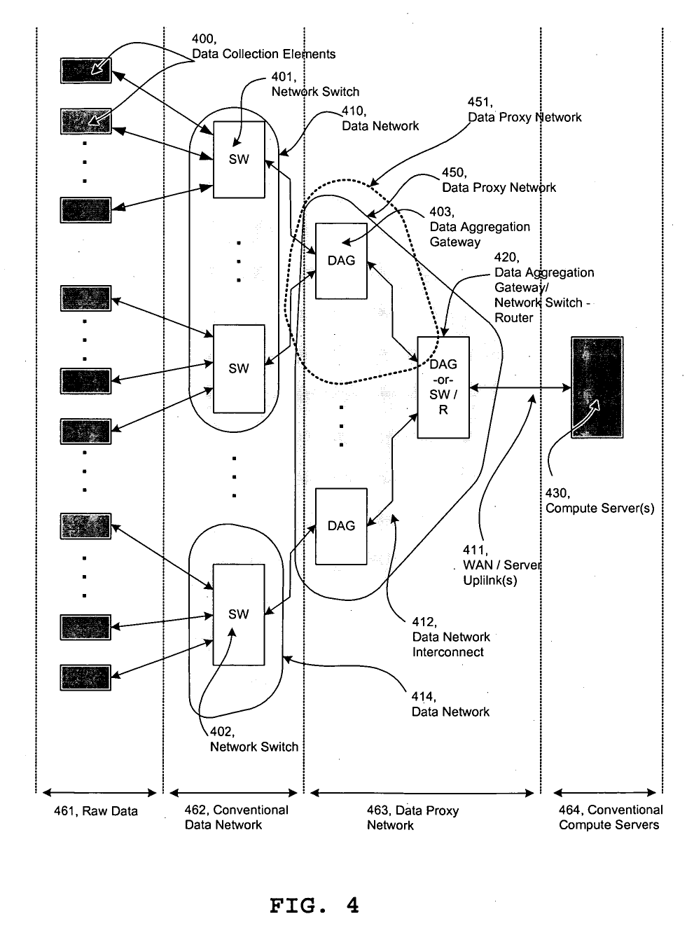

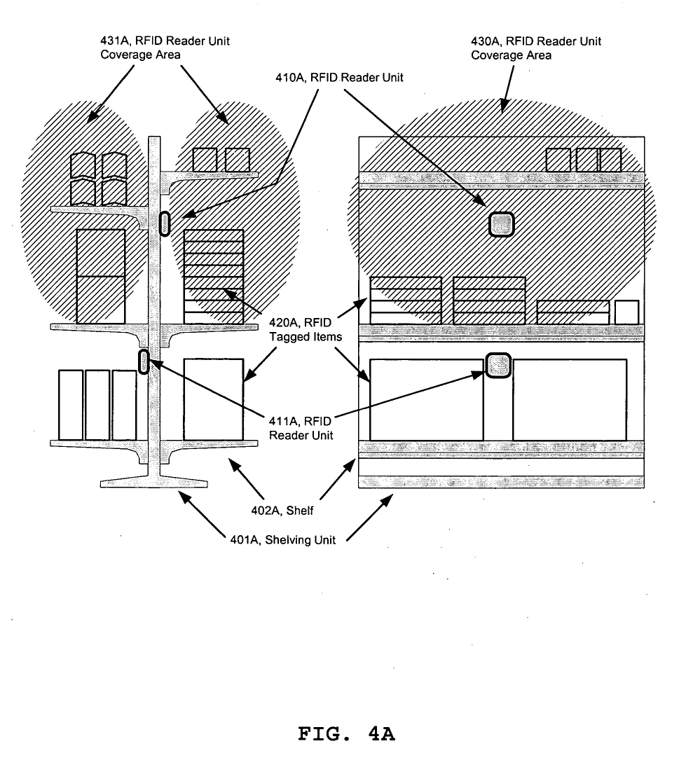

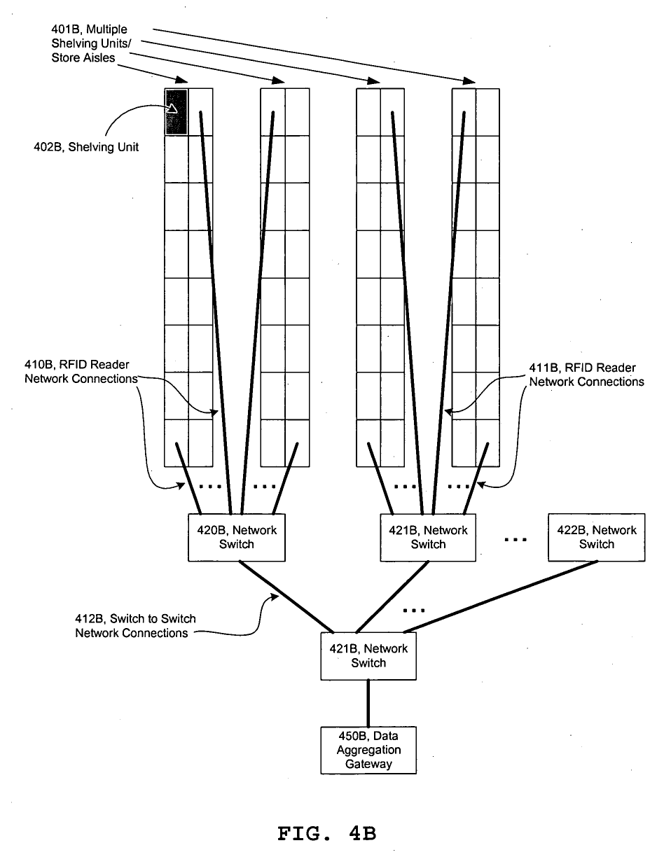

FIG. 4 illustrates the data collection system of FIG. 3, with the introduction of a system embodying one aspect of the present invention, a Data Proxy Network 450 between the Data Collection Elements 400 and the Compute Servers 430. Data Aggregation Gateways (DAG) 403, 420 form a Data Proxy Network 450 between the Data Collection Elements 400 and the Compute Servers 430.

The Data Aggregation Gateway 403, 420 topologically replaces and optionally subsumes nodes in a data network that might otherwise be data forwarding nodes such as network switches or routers. With a Data Aggregation Gateway 420 inserted in the flow of data in a network, the Data Aggregation Gateway may perform a number of application aware actions, transforms, and various processing steps; for example, it may act as a proxy and aggregation point for the associated Data Collection Elements 400 to upstream compute servers; it may act as a demarcation point separating upstream systems from downstream systems in general by presenting upstream systems an abstracted, reformatted, pre-processed, encapsulated or otherwise transformed view of the downstream systems to upstream systems and vice versa. In the current art, network nodes such as switches and routers are only permitted to forward, delay and drop data; they are not permitted to modify, consolidate or offer alternate representations of the application data they convey. In contrast, the Data Aggregation Gateway 420 may perform operations on the ingress data from the Data Collection Elements 400 such as packet consolidation, culling (based on application level rules) and various application aware transforms before presentation to application clients. Examples of application clients include Compute Servers 430 or other Data Aggregation Gateways 403, 420.

For multi-layered Data Proxy Networks 450, sub Data Proxy Networks 451 are formed, partitioning both the computational load per Data Aggregation Gateway 402, 420 and the total amount of traffic generated at each stage.

Thus, the Data Aggregation Gateway enables new, distributed and scalable data collection architectures by isolating redundant traffic within the Data Network 410 and presenting only preprocessed and conditioned traffic from any stage in the Data Proxy Network 450 to any upstream stage. By partitioning both the network bandwidth load and the computational load per stage, the so called “data smog” problem can be effectively mitigated.

The staging of data is illustrated in FIG. 4. Raw data 461 enters the system via Data Collection Elements 400 (for example, RFID or optical tag readers); the resulting data is aggregated as-is by a Conventional Data Network 462 and presented to the Data Proxy Network 463. Within the Data Proxy Network, the processing workload is distributed over one or more Data Aggregation Gateways 403, 420.

Thus, the Data Proxy Network 450 consists of one or more Data Aggregation Gateways 403, 420 situated between one or more Data Collection Elements 400 (and their associated Data Networks 410) and one or more Compute Servers 430. The Data Aggregation Gateway 403, 420 combines certain networking, forwarding, and packet transform functions along with application level database and data manipulation capabilities to enable data collection networks that achieve hierarchical workload and bandwidth isolation.

In scenarios where data is changing slowly relative to the sensor's sample rate, much of the data reported by a sensor in a sensor network will be redundant; by extension, much of the data in the attached Data Network 410 will be redundant. For example, an RFID reader will probably report the same set of items on a shelf from second to second and minute to minute as it is instructed to read the tags on merchandise within its coverage area. Similarly, an ocean water temperature sensor on an oil platform will read substantially the same data from second to second. In the event of a change in temperature or a change in the status of an item on the RFID reader's coverage area, the change should be noted promptly to upstream systems. Furthermore, if the item is, for example, a box of heavy explosives that is not authorized for removal from storage, the notification should be extremely prompt and may potentially propagate quickly through a number of systems before action is taken. Until then, the RFID reader that covers that box of explosives may report the presence of the same tag, associated with that box, hundreds or thousands of times a day. This unfiltered flow of reader data contributes heavily to the data smog problem.

In scenarios where data is changing or arriving quickly (such as the receiving bay in a large retail or warehouse facility) there may be a number of readers attempting to read tag data from items entering the receiving bay on conveyor belts. Generally, one or more readers will be able to read the tag on any given item, but in rare instances only one will be able to read a given tag. While the reported data needs to be sent upstream at some point, the average multiplication of data in a high-throughput, multi-reader setting can contribute substantially to the data smog problem as both additional network bandwidth and additional computation load upstream.

To compound the data smog problem, packets of data arriving from the Data Collection Elements 400 are typically very short compared to the minimum L2 frame size of the protocol used by their Data Network 410. For example, if the Data Collection Elements 400 are RFID EPC readers connected to Ethernet and are generating standard Ethernet frames to convey information, only approximately 96 bits (12 bytes) of the 368 bit (46 byte) data payload are actually being used; the rest are overhead to produce a minimum length (64 byte), correctly formed frame. This bandwidth expansion contributes to the data smog problem and the large number incoming Ethernet frames with only partially populated payloads reduces software efficiency at the upstream server receiving the frames of data.

Thus, one key function of the Data Aggregation Gateway 403, 420 will be to condition raw data arriving from the Data Collection Elements 400 according to a specific embodiment. Consolidation is a primary conditioning strategy; consolidation will take three basic forms:
1. Payload Consolidation: The simplest consolidation function will be to gather multiple data packets into fewer data packets (with larger payloads each) and therefore lower Layer 2/Layer 3 overhead per reported tag datum. A programmable timeout mechanism may be employed by this conditioning function to limit the maximum time a given larger packet may sit waiting for smaller incoming packets before the larger packet must be emitted.
2. Sample Redundancy Consolidation: The second consolidation form reduces redundant application layer data by culling tag data that has been recently reported by a given tag. A minimum, programmable wait time is imposed before a given tag may report its presence to an upstream application. If used in combination with Payload Consolidation, the combined payload roll call data will be limited to culled data emitted by the Sample Redundancy Consolidation function.
3. Semantic Transformation: The third consolidation form eliminates the need for periodic reporting by transforming the semantics of reporting from a roll call to an indication of difference. Thus, as new tag IDs are added to the scan coverage area of a Data Collection Element, those IDs are reported with an “Added” indicator; as items go missing, they are reported as “Removed”. A programmable minimum amount of time must elapse before an item may be reported as missing. If used in combination with Payload Consolidation, data packets emitted by Semantic Transformation may be either emitted separately or combined via Payload Consolidation.

FIG. 4A illustrates a retail shelving unit 401A with RFID Reader Units 410A and 411A providing coverage to the various regions enclosed by the Shelving Unit. Each Shelving Unit will have at least one Shelf 402A which will typically be used to hold RFID Tagged Items 420A. A given RFID Reader 410A will provide some Coverage Area 430A 431A, which may or may not encompass the entire volume of the Shelving Unit 401A. Thus, multiple RFID Reader Units may be needed to fully cover a given Shelving Unit. Alternately, multiple antennas may be attached to a smaller number of RFID Reader Units; this has the effect of reducing the number of RFID Reader Units, but not the number of total antennas needed. Special consideration should be given to Shelving Units with metal components, as these components will tend to obscure the RFID tags on or in the Tagged Items from the RFID Reader Units. The practical consequence of metallic (or other RF reflecting or RF absorbing) material is that more antennas are needed than maximum reader-tag distances would otherwise suggest. Each shelving unit will contain a number of RFID Reader Units, with each RFID Reader Unit requiring a network data connection and contributing to system network traffic.

Multiple Shelving Units will be organized into aisles, and aisles into floor spaces. A potentially large number of RFID Reader Units (in general terms, Data Collection Elements) will therefore participate in the complete data collection system. This large number of Data Collection Elements will produce potentially large volumes of data and require significant configuration and management overhead, as discussed previously. FIG. 4B illustrates the concepts discussed in general terms in FIG. 4, as applied specifically to retail RFID deployment. The Data Collection Elements 400 of FIG. 4 correspond to one or more RFID Reader Units 410A, 411A of FIG. 4A. The Conventional Data Network 462 and Network Switches 401, 402 of FIG. 4 correspond to the RFID Reader Network Connections 410B and LAN Network 415B of FIG. 4B. In FIG. 4B, the LAN Network 415B is preferably an Ethernet or Powered Ethernet (“Power over Ethernet”, IEEE Std. 802.3af) network, whereby the Ethernet signal cabling also carries power to the end device(s). Alternately, serial data connections may be used.

In FIG. 4B, data is generated by RFID Reader Units 410A, 411A and aggregated by a LAN Network 415B, until the data is then fed to a Data Aggregation Gateway 450B, having properties discussed herein. Principally, the Data Aggregation Gateway presents a proxy device view of the RFID Reader Units and a proxy data view of the data the RFID Reader Units are generating. In this way, management and configuration overhead is abstracted by the Data Aggregation Gateway and data is conditioned in the Data Aggregation Gateway so as to avoid excessive network bandwidth or computational load on client machines attempting to read tag data. Further details of the present systems and methods can be found throughout the present specification and more particularly below.

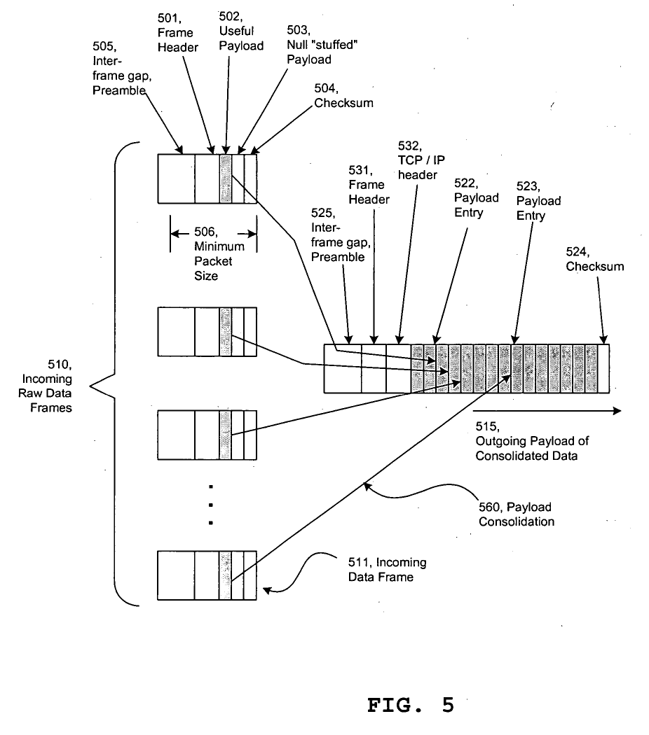

FIG. 5 illustrates the Payload Consolidation of packet payloads. Incoming Raw Frames 510 (constituting whole or partial data packets) may arrive at a Data Aggregation Gateway 403 from one or more Data Collection Elements 400 or Network Switches 401. Each incoming packet 511 must be a properly formed, framed and reassembled (if segmented over multiple frames), given the network technology in use. Ethernet is an example of an appropriate network technology in this setting. In many data collection networks, the unit of data being collected in any one transaction is rather small compared to the minimum size 506 of, for example, an Ethernet frame. To convey a single unit of useful data 502 over Ethernet, the Ethernet payload may need to be “stuffed” with null data 503 for very small units of data (i.e., less than a 6 byte payload for TCP/IP-based protocol encapsulation). More significant than potential null data is the basic overhead of a TCP/IP packet mapped into an Ethernet frame. The Ethernet inter-gap and preamble bits 505 total 20 bytes minimum; the MAC (Layer 2) header 501 are another 14 bytes; a TCP/IP header inside the Layer-2 payload area adds another 40 bytes; finally, the Ethernet checksum is another 4 bytes. In total, a minimum of 20+14+40+4=78 bytes of overhead are needed to send a basic TCP/IP packet over an Ethernet frame. An example of a useful payload would be the 96 bits defined in a standard EPC tag. The 96-bit EPC tag totals 12 bytes, leading to an Ethernet frame that is 90 bytes long if a TCP/IP-based Ethernet protocol is used; thus, only 12 bytes out of 90 bytes are actually conveying payload when EPC tags are sent one TCP/IP packet at a time, as current practice dictates. Both overhead data and payload data contribute to network bandwidth; current practice therefore leads to unnecessarily high network utilization.

By consolidating the payloads of multiple Incoming Data Frames 510, greater network efficiency is achieved. Multiple payloads 522, 523 share the same inter-frame gap and preamble overhead 525, Ethernet header 531, TCP/IP header 532 and checksum 524 fields. By consolidating 120 EPC tag payloads into a near maximum sized standard Ethernet frame, raw network efficiency increases from under 18% to over 96%. By consolidating 740 EPC tag payloads into a maximum sized “jumbo” Ethernet frame, raw network efficiency increases to over 99%.

Note that with long packets, the probability of any one packet experiencing a bit error (typically reported by the checksum mechanism) is increased proportionally; thus, this invention contemplates the application of error correction within the consolidated payload as a means to potentially avoid re-transmission of packets should there be an implementation or efficiency advantage versus the well known and commonly applied re-transmission strategy employed in such reliable transmission protocols as TCP/IP.

There is an additional benefit to reducing the number of packets being presented to an upstream server application: there is computational overhead associated with handling an incoming Ethernet frame. By consolidating multiple payloads into a single frame, the upstream server's computational overhead is reduced while network efficiency is simultaneously increased.

The previously described consolidation of multiple payloads is possible in this instance because the producers of data, the Data Collection Elements 400, are all ultimately communicating with the same upstream application in a very specific way. In general, data packets cannot be combined this way in a data network by switches or routers, which have no awareness of application data formats.

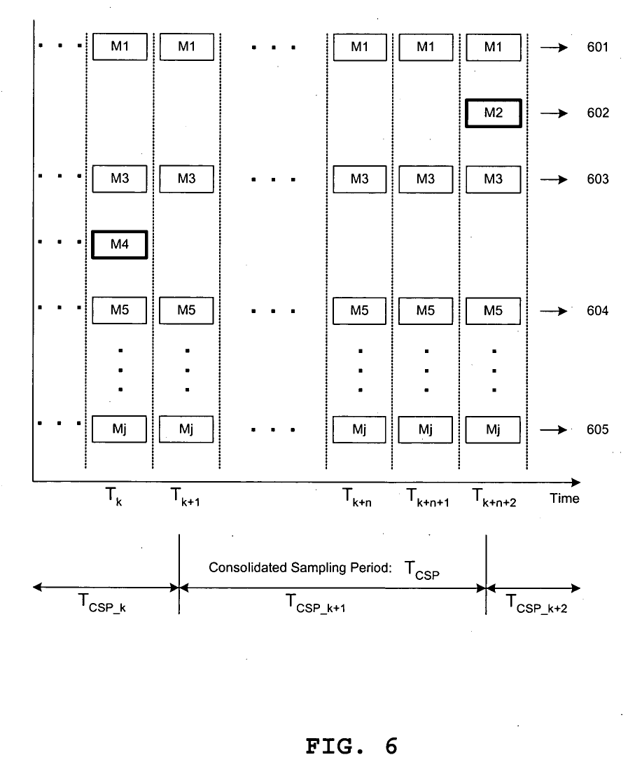

FIG. 6 illustrates tag “roll call” messages arriving from readers in an example data collection system based on RFID tags. Messages arrive from tags M1 through Mj within time intervals T(k), T(k+1), T(k+n), T(k+n+1) and T(k+n+2). Each tag reader gathers data constantly, periodically, or in response to an up stream application. Using appropriate means, the upstream application(s) on the Compute Server(s) 430 receive and process all messages (“M1 reporting”, “M3 reporting”, etc.) from the readers, as shown in FIG. 6. Within a given time interval Tk, the reader must successfully read and report all tags that the reader covers. The presence of a given tag in that time interval is represented by a message “M-tag_number” such as “M1” in intervals T(k) through T(k+n+2).

In RFID systems, where environmental factors such as ambient RF noise may cause unsuccessful reads to occur, it is advantageous to “over sample” the tags. For instance, one or more tags may not be successfully read in time period Tk+n but are then successfully read in Tk+n+1; different tags may go similarly missing for a different time period. The second conditioning strategy, Sample Redundancy Consolidation, provides the mechanism for gathering more than one read period (Tk to Tk+1) worth of sampled tag data and presenting the complete set of samples to an upstream application once per N (where N is greater than 1) reader time periods. FIG. 6 illustrates the concept of a Consolidated Sampling Period (Tcsp). In Tcsp_k, M4 is reported. M4 is then removed between Tk and Tk+1; M4 is therefore not seen by its reader from Tk+1 to Tk+n+2 (the Consolidated Sampling Period Tcsp_k+1) and not reported in Tcsp_k+1.

Sample Redundancy Consolidation can be utilized in one or more stages to accomplish multiple different goals. The goal of the first stage of Sample Redundancy Consolidation may be, for example, to remove transient read errors due to physical read channel issues (i.e., RF noise). The Consolidated Sampling Period may be seconds to minutes; in other words, the time to physically move an item from one place to another in a site covered by scanners. The second stage may have a time scale of hours, where daily inventory tracking is the goal. A third stage may be have a time scale of hours to days, where inventory tracking, reordering, and trend forecasting is the goal.

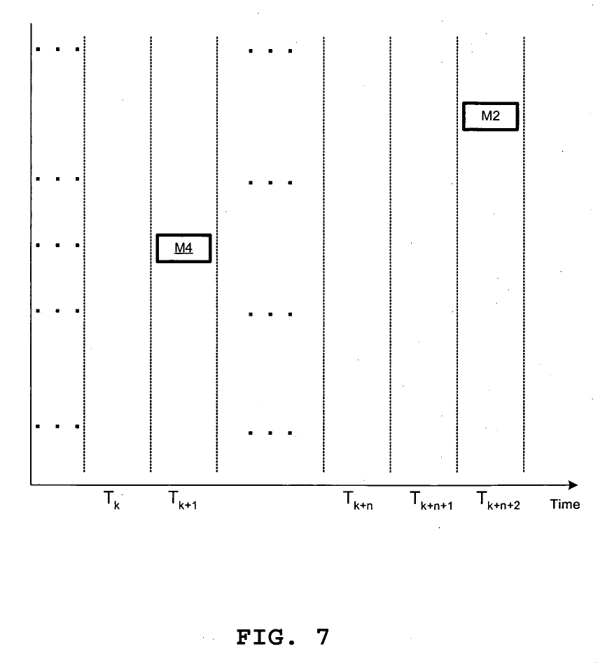

Despite the efficiency gains in messaging made possible with Sample Redundancy Consolidation, much of the data in FIG. 6 is still quite redundant, even at lower reporting intervals, given by Tcsp. For example, by time T(k), M1 and M3 to Mj are already present. At time T(k+1), M4 is removed (M4, “M4 removed”). At time T(k+n+2) M2 is introduced to the mix (“M2 Added”). FIG. 7 illustrates the minimum data needed to convey the equivalent information reported in FIG. 6. The Semantic Transformation conditioning strategy accumulates and maps data from the “roll call” semantic to the “difference” semantic.

With Semantic Transformation conditioning, the tag readers must still gather all the raw tag data, illustrated in FIG. 6, and report this tag data to the Data Aggregation Gateway for processing as outlined above.

Both Sample Redundancy Consolidation and Semantic Transformation require the Data Aggregation Gateway to construct and maintain a database of all known tag IDs. With the database of known tag IDs, the Data Aggregation Gateway can track individual roll call time outs and/or generate “status change” messages indicating a difference of tag status based on recent roll calls. These status change messages minimally consist of “ID added” and “ID removed”. A newly encountered tag will generate an “ID added” message, while a tag that goes missing will result in an “ID removed” message if the time the tag is missing exceeds a programmable threshold. The missing time threshold is necessary to avoid spurious “ID removed” messages in scenarios with low reader reliability, as may be the case in electronically noisy or highly obstructed settings.

Three conditioning strategies have been discussed. The first strategy consolidates multiple data packets into larger data packets to significantly improve network efficiency. The second strategy consolidates application layer data by effectively re-sampling tag data, thus reducing redundancy in that application data. The third strategy transforms the semantics of data reporting from roll calls to change notices, thus eliminating redundancy in the application data.

In many RFID reader deployment scenarios, reader coverage will likely overlap, potentially resulting redundant reports of the same tag ID. This phenomenon is referred to as “reader collision”. The above three conditioning strategies provide a basis for the Data Aggregation Gateway providing anti-collision means. The Data Aggregation Gateway may record which readers are reporting a given tag ID, but the inventory reported by the Data Aggregation Gateway will include exactly one instance of the tag. Optionally, the Data Aggregation Gateway will provide means for conveying a list of all readers reporting the same tag ID as an attribute associated with that tag ID; all read stability rules could apply as appropriate. The Data Aggregation Gateway may be configured to select a primary reader with which to associated redundantly reported tag ID values based on a policy such as signal strength, reader attribute (IP number, MAC address, etc.), tag attribute or read stability from each reader.

In a preferred application of this invention, the data management systems receiving conditioned data from the Data Aggregation Gateway would be compatible with all three conditioning strategies. In such a scenario, the three data conditioning strategies would be used in combination to produce consolidated packets, reporting multiple status changes, while benefiting from the smoothing, re-sampling effect of Sample Redundancy Consolidation.

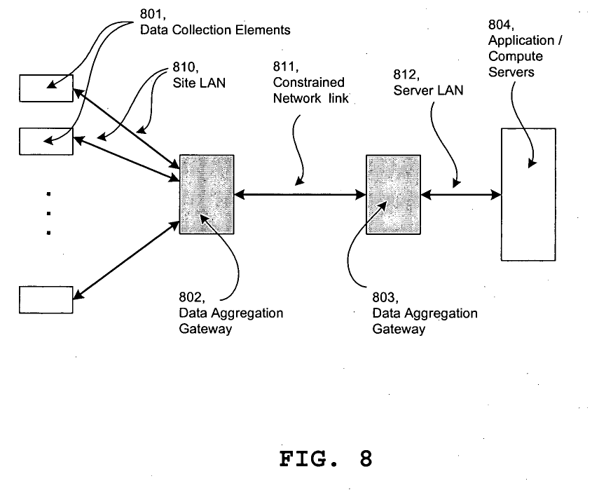

In an alternate embodiment, the conditioning strategies are used as a means to compress data over an expensive network resource, such as a Wide Area Network (WAN) link. This is illustrated in FIG. 8. Data Collection Elements 801, such as RFID tag readers gather data and present it via a site LAN 810 to a first Data Aggregation Gateway 802, which applies one or all of the data consolidation strategies previously discussed. The significantly reduced upstream data bandwidth is then applied to a constrained (or expensive) network link 811; an example WAN link would be a T1 WAN line. A second Data Aggregation Gateway 803 is situated on the upstream (headquarters or central office) side of the network link 811; this second Data Aggregation Gateway 803 inverts some or all of the data consolidation transforms applied by the first Data Aggregation Gateway 802. The primary goal of inverting the data consolidation transforms is to format the tag data to conform to requirements set by the data management application(s) executing on the Compute Servers 804. For example, if the data management application is written to expect raw data from the readers, then each consolidated data packet must be elaborated into individual messages as though those messages came directly from one or more readers.

There is potentially some flexibility in the timing of transforming consolidated difference information back into individual tag ID messages. For example, the applications running on the Compute Server 804 may require a fully elaborated set of messages for each tag read, but those applications may be configured to expect that list only once an hour or once a day.

An example where this flexibility exists is a retail setting where tags are read on a minute-to-minute basis to track items through the selection, purchase and exit check processes. An item removed from its shelf is reported “removed” by its reader. At this point, the item is considered mobile within the facility and may spuriously reappear in the coverage zones of other readers throughout the store as the item makes its way to checkout; the item must now pass through a purchase process to successfully pass an exit check by the exit tag reader.

Any brief reappearance within the facility should not show up as “item reporting” messages to applications upstream from their respective Data Aggregation Gateway(s). However, if an item is reported by a given reader for some programmable length of time, the respective Data Aggregation Gateway will generate an “item reporting” message upstream. At this point, the item may have been abandoned on a random shelf or replaced on the correct shelf; either way, the item's presence should be reported.

A retail site may implement perpetual tracking on a minute-to-minute basis for the purpose of implementing theft detection procedures, tracking on an hourly basis for re-shelving procedures, and a nightly basis for inventory management. The corporate office central to many retail sites may implement nightly tracking to implement global supply base management and ordering procedures. Minute to minute through daily sampling represents a fairly asymmetric data reporting structure and presents opportunities for greater architectural efficiency.

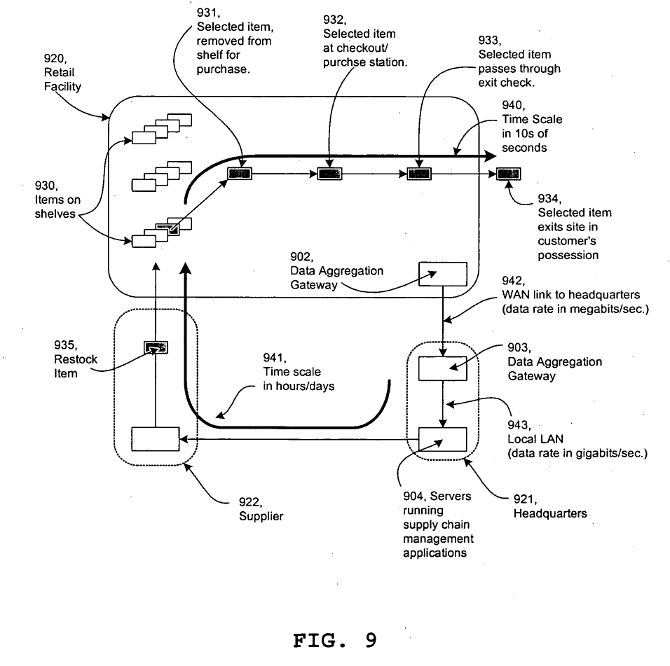

FIG. 9 illustrates the asymmetric reporting requirements in the above retail scenario. Within the Retail Facility 920, the sampling Time Scale 940 must be faster than one minute to properly capture an item's removal from a shelf, purchase and exit check. When the selected item passes through the exit check 933, the tag reader(s) responsible for monitoring the exit must be capable of providing real time tag data for tags exiting the Retail Facility 920 in order to flag a potential theft. The time scale here is potentially seconds. While tag data updates every minute or less are important in the setting of a Retail Facility 920, it is not significant in managing the supply chain. The time scale 941 for generating and placing orders with Suppliers 922 is measured in hours or days. Restock Items 935 (individual, cartons or whatever granularity is appropriate) need only arrive in time to be restocked before the shelf runs out of those items; again, this time scale is hours to days.

Supply chain management (inventory and trend tracking, purchase order generation for restocking, etc.) is sited here as one example of many possible data management application relevant to this discussion.

In this scenario of FIG. 9, the second Data Aggregation Gateway 903 can transparently provide periodic (hourly or daily) updates locally to data management applications on the Headquarters 921 local LAN 943 by periodically instantiating a tag ID message for each present tag ID from it's retained database of current tag IDs. This process may result in a significant volume of bandwidth offered to the Local LAN 943; fortunately, gigabit data rates are available on the Local LAN 943. Also in this scenario, the supply chain management servers and applications 904 need not be compatible with the bandwidth reduction strategies employed by the Data Aggregation Gateway 902 because the second Data Aggregation Gateway 903 inverts the effect of the consolidation transforms discussed earlier.

To illustrate the benefit of the data consolidation strategy employed by this invention, consider an RFID deployment appropriate for a large retail site with 1000 readers, each providing 100 tag ID reads per second. This allows for a total retail stock of 1 million items to be queried once every 10 seconds. While a 10 second inventory tracking interval is appropriate for tracking items through the selection and purchase process, it represents approximately 72 megabits/second of bandwidth (assuming 90 byte packets). 72 megabits/second is nearly two orders of magnitude more bandwidth than a T1 line can provide. In contrast, if this retail site generates approximately 6000 transactions of items leaving the facility (purchases) per minute, and each purchase generates a 90-byte message frame (to convey a 96-bit EPC code), the difference data is less than 100 kilobits/second. The Data Aggregation Gateway 902 absorbs the 72 megabits/second of aggregate tag reader data, consolidating this tag data into change data that can easily pass over a T1 or partial T1 line. On the upstream side, the data can be elaborated back into the original 72 megabits/second of what appears to be raw tag reader data that conforms to the basic compatibility requirements of the management applications.

In a preferred embodiment, data management applications running on the upstream Servers 904 are able to interpret the consolidated data formats directly from the first Data Aggregation Gateway 902, eliminating the need for a second Data Aggregation Gateway 903 and eliminating the additional computational load of absorbing 72 megabits/second (in the example) of tag data.

An additional strategy for reducing bandwidth provides for an M-bit to N-bit reduction per “ID removed” message, while adding an additional burden of N-bits to the “ID added” message. Obviously, there are combinations where such a reduction is not beneficial. However, for certain anticipated standards such as EPC, this reduction may prove beneficial for both network bandwidth and computational loading on data management applications. This referencing model, hereafter referred to as “index referenced”, relies on the observation that an “ID added” message contains unique tag information, whereas an “ID removed” message contains a redundant copy of this tag information. The normal (non-indexed) referencing model in identifying tag IDs will be referred to as “tag referenced”.

The current generation EPC tag ID contains 96 bits of information and future generations of EPC codes will contain 256 bits of tag information. To indicate an EPC tag has newly been added to the group of tags visible to a reader, a Data Aggregation Gateway may generate a message indicating “ID added”, with the 96 or 256-bit tag data. When that tag fails to report in for some programmable length of time, the Data Aggregation Gateway generates an “ID removed” message with the associated 96 or 256-bit tag. Using an index referenced model, the Data Aggregation Gateway assigns an M-bit index when the “ID added” message is sent; and sends the same index with an “ID removed” message. Using EPC codes as an example, and using an index of 32 bits, then an “ID added” message would be 96+32=128 bits (or 256+32=288 bits), whereas an “ID removed” message would always be 32 bits versus 96 (17% payload bandwidth savings) or 256 bits (43% payload bandwidth savings). A 32-bit index provides for 4 billion unique items under the management of one Data Aggregation Gateway.

EPC tag data will likely contain significant redundancy in both vendor and serial number fields (primarily the most significant serial number bits); this invention contemplates the use of loss less compression to convey tag data both in index referenced messaging (for initial “add” messages) as well as tag referenced messaging (roll call and difference messages). A number of suitable compression algorithms are known to those skilled in the art of loss less compression and include classes of algorithms based on run length encoding and recursive and/or non-recursive codebook encoding.

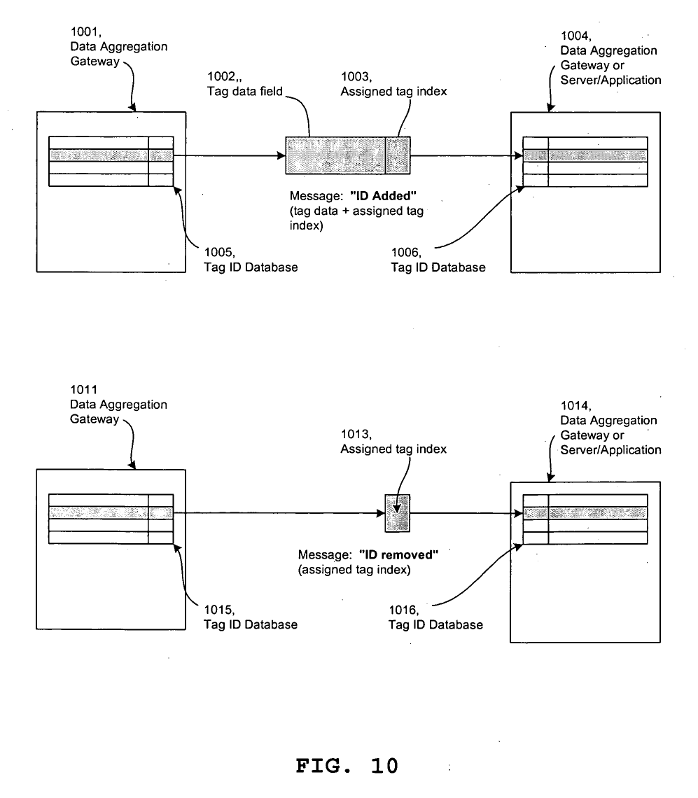

FIG. 10 illustrates the index referenced model for “ID added” and “ID removed” messages. When a tag reader reports a tag ID that is not listed in the Tag ID database 1005, that tag ID is added to the Tag ID Database 1005 local to the respective Data Aggregation Gateway 1001. When the Data Aggregation Gateway 1001 reports the newly added tag ID with an “ID Added” message 1009, an index 1003 is assigned and applied to the tag ID for future reference; an example index assignment policy would be to utilize the local downstream index table reference number used by the Data Aggregation Gateway 1001. When the upstream Data Aggregation Gateway 1002 receives the “ID added” message (along with an assigned tag index 1003), a new table entry is created in the respective Tag ID Database 1006 in the upstream Data Aggregation Gateway 1002. This allows the upstream Data Aggregation Gateway to track the downstream tag ID data with just an index number instead of a complete tag ID (for example, a 20, 24 or 32 bit index instead of the full 96 or 256 bit tag). In multi-tiered Data Aggregation Gateway networks, the downstream device preferably assigns the tag index, conveying the associated index upstream in a corresponding “ID added” message. Each Data Aggregation Gateway can assign an index from its local space.

There are numerous well-known techniques for hashing, indexing or otherwise compressing units of data well known to those skilled in the art of data coding and compression. Such methods are contemplated by this invention as a means for reducing bandwidth, computational load or both.

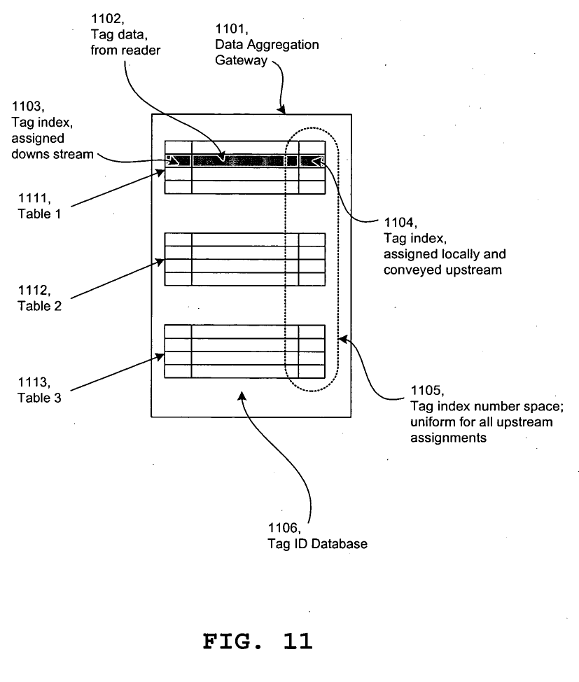

FIG. 11 illustrates the index referenced number space between levels of a multi-tiered Data Aggregation Gateway system. The Data Aggregation Gateway 1101 in FIG. 11 contains three tables in its Tag ID Database 1106: Table 1 1111, Table 2 1112 and Table 3 1113; each containing a Tag index assigned downstream 1103 and a set of Tag indices conveyed upstream 1104 that exist in a uniform Tag index number space 1105. In this way, a number of downstream Data Aggregation Gateways can present themselves as a single entity upstream, with a consistent index referenced messaging model.

In a preferred embodiment of this invention, the Data Aggregation Gateway can both accept and generate messages in index referenced or tag referenced modes, including a simultaneous mix of the two; furthermore, the Data Aggregation Gateway can translate between the two models for the benefit of upstream systems that may be incompatible with either referencing model.

Data Consolidation functions of the Data Aggregation Gateway have been outlined to this point. Data Elaboration (the inverse of Consolidation) has also been mentioned in the context of providing compatibility with systems requiring data in a raw reader format. These two features of the invention described herein establish a context for discussing the full functionality of the invention.

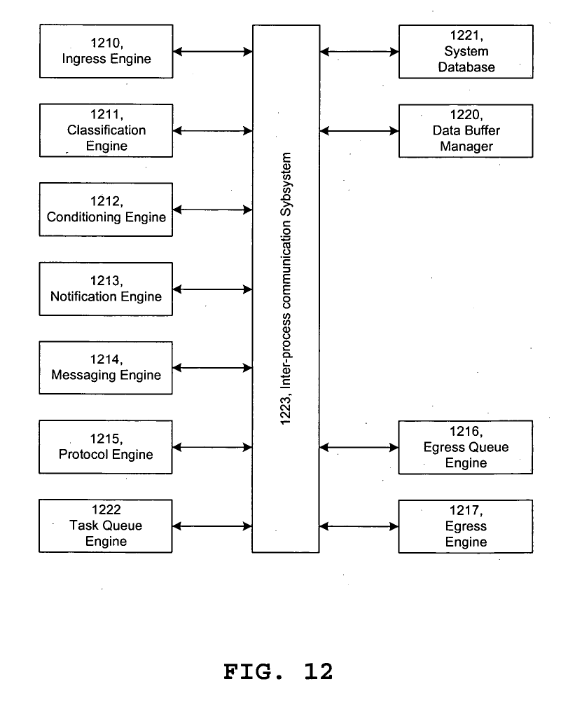

FIG. 12 outlines the key functional groups and data flow contemplated for the data conditioning portion of this invention; various subset combinations of this functionality are contemplated in this invention.

The Ingress Engine 1210 accepts data packets from a network interface such as Ethernet, SONET or T1. The incoming data packets are stored in the Data Buffer Manager 1220. The Ingress Engine 1210 may optionally structure or pre-parse the incoming data if a specific implementation benefits from structuring or pre-parsing data at this point. The Ingress Engine 1210 may also provide packet reassembly service if implementing packet reassembly at this point has an implementation benefit. Depending on the requirements of a specific implementation, the functionality of the Ingress Engine 1210 may or may not overlap, encompass or augment the functionality of a standard network protocol stack such as IP or TCP/IP. The Ingress Engine 1210 may bypass the operating system's TCP/IP stack for certain types of traffic and forward other traffic to the TCP/IP stack. For example, system management packets will be presented to the operating system's TCP/IP stack (no bypass), whereas tag ID data may optionally bypass the TCP/IP stack. In this way, the Ingress Engine 1210 performs rudimentary classification functions; the match criteria may include the packet's destination L2 MAC address, destination IP address, etc.

The Ingress Engine 1210 may additionally perform packet verification services before handing off a given packet. Such services may include checksum checks and malformed packet checks.

The Classification Engine 1211 parses the incoming data packets, structures their content and identifies what type of action, if any, is to be taken in response to their arrival. The Classification Engine 1211 utilizes programmable pattern matching within programmable search fields contained in a packet to determine what action should be taken. For example, the Classification Engine 1211 may be programmed to look into packet payloads for tag IDs from a specific field such as vendor ID; packets from this vendor may identify high priority handling.

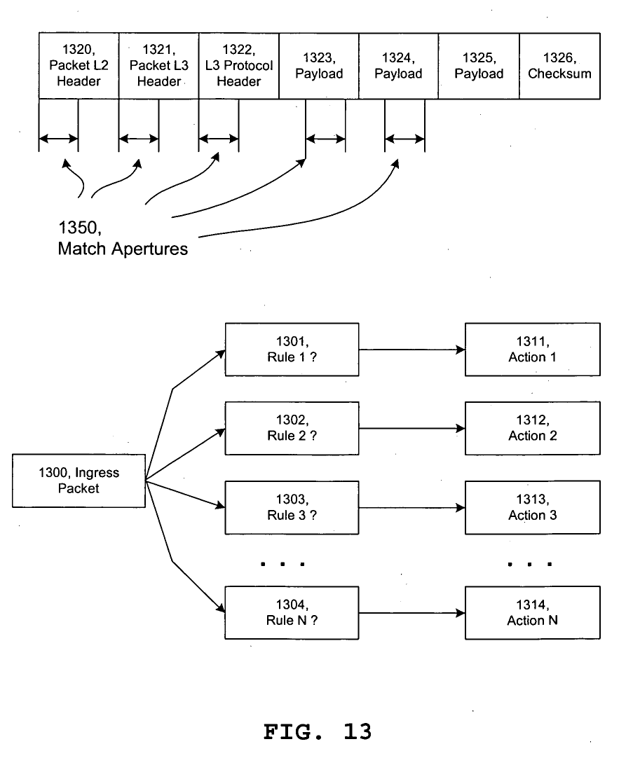

FIG. 13 illustrates the concept of mapping a matched rule to a predetermined action. An Ingress Packet 1300 is presented to the Classification Engine 1211, where the header and contents of the packet are examined for matches to programmable Rules 1301 to 1304. Each Rule has a programmable set of one or more Match Apertures 1350 that can be set to examine arbitrary bit fields in a packet under examination. The bit fields will correspond to fields or sub-fields within the packet's header blocks 1320, 1321, 1322 or payload blocks 1323, 1324, 1325. A Rule may be defined as a simple match against a single Match Aperture or a Rule may be a composite of multiple match requirements. Furthermore, the matches may be hierarchically defined such that primary matches guide the selection of dependent sub-rules.

Once a Rule has been matched, the Classification Engine 1211 will then map the rule to a predetermined programmable action 1311, 1312, 1313, 1314. The act of mapping the rule will generally consist of attaching an attribute to the packet and queuing the packet up for action. Optionally, the Classification Engine directs the packet to a specific module to conduct the specified action. Some example Actions include:
1. Sending packets to specific processing queues for later processing or conditioning.
2. Setting priority levels for packets containing tag data; this may include setting header bits (for example 802.1p, TOS or DiffServ attributes) based on tag data content.
3. Setting egress header bits based on ingress header or tag content bits; for example, to forward packets from reader N to server IP number M.

The classification functionality is therefore constructed to be very general, whereas the actual Rules are programmed to be specific to the application(s) at hand.

The Classification Engine 1211 may implement one or more of the response actions.

If the Classification Engine 1211 determines the data frame is destined for the Conditioning Engine 1212, then the Conditioning Engine 1212 is notified. The Conditioning Engine 1212 employs the following strategies to reduce bandwidth:
1. Consolidating smaller data packets into larger packets
2. Culling redundant information by reporting information less frequently
3. Transforming redundant roll call information to differences messages
4. Transforming tag referenced data into index referenced data

Additionally, the Conditioning Engine 1212 employs data smoothing strategies to reduce or eliminate spurious data. One key data smoothing strategy sets thresholds for missing data; thus, a tag ID must go missing for a programmable length of time (or reader intervals) before its absence is reported. In a preferred embodiment, the smoothing and culling strategies cooperate in their operation.

The Conditioning Engine 1212 can allocate buffer space via the Data Buffer Manager 1220 to assemble new, larger consolidated outbound packets from smaller inbound packets. In a preferred embodiment, the Conditioning Engine 1212 sets a programmable time limit for assembling consolidated packets; in this way, the consolidation process avoids burdening already arrived data packets with unbounded latency. Furthermore, a preferred embodiment of the Conditioning Engine 1212 provides programmability in enabling, disabling and configuring each function independently.

The Conditioning Engine 1212 can be configured through a command set within a Command Line Interface (CLI), a GUI, XML, SNMP, or other appropriate management means.

The Notification Engine 1213 sets programmable timers, pattern matching functions and other means to monitor stored data and respond to it in an appropriate time frame and based on programmable rules. In a preferred embodiment, the Notification Engine 1213 would also receive messages from the Classification Engine 1212 for high priority notifications.

The Notification Engine 1213 should, at a minimum, have the capability to attach specific rules to individually known tag IDs. When a rule is triggered, the Notification Engine 1213 generates an associated programmable response, sending the response to the Messaging Engine to format. An example action of the Notification Engine may be to upload the current tag database in response to a timer trigger.

The Notification Engine 1213 can be configured through a command set within a Command Line Interface (CLI), a GUI, XML, SNMP, or other appropriate management means.

The Messaging Engine 1214 formats outbound payloads to match a specific, programmable schema that represents the notification message in conformance to an upstream server's requirements. In a preferred embodiment, the Messaging Engine 1214 supports be a plurality of simultaneously available schemas, assembled in a modular, extensible architecture. In a preferred embodiment, the Messaging Engine 1214 sends a reference to its formatted message to the Protocol Engine 1215, where the message is encapsulated in a standard network packet format and queued for egress with appropriately built headers. Alternatively, the Messaging Engine 1214 directly formats the packet for egress.

The Messaging Engine 1214 can be configured through a command set within a Command Line Interface (CLI), a GUI, XML, SNMP, or other appropriate management means.

The Egress Queuing Engine 1216 implements the egress queuing policies and priority mechanisms, based on the application requirements. This invention contemplates various queuing schemes well known to those skilled in the art of networking or queuing systems. Example queuing schemes include a basic priority queue and weighted round robin queue. In a priority queue, the Egress Queuing Engine 1216 assigns greater egress priority to high priority messages (for example, an unauthorized removal of explosive material, indicated by high priority message flags) over low priority messages (the box of cereal is still on the shelf, as indicated by low priority message flags). The Egress Engine 1217 implements the interface specific details. In certain instances, it may be advantageous from an implementation standpoint to combine the functions of the Egress Queuing Engine 1216 and the Egress Engine 1217 into a single Engine.

The Data Buffer Manager 1220 is a memory manager subsystem for ingress and egress packets while they are being processed. Thus, the Data Buffer Manager 1220 allocates and de-allocates buffer space to incoming data frames/packets as well as newly generated and in-progress frames/packets.

The System Database 1221 implements a number of complex functions, including tag ID lookup, tag ID management and attribute management. When a tag reader reports a given tag ID, the System Database 1221 conducts the lookup; the lookup function searches for the contents of that tag ID within the known database of tag IDs. If the tag ID is not present, the System Database 1221 reports a lookup miss back to the requesting engine and conditionally enters the tag ID into the database of known ID tags. If the tag ID is present, the System Database 1221 reports a hit, along with an attribute index that can be used examine the attributes associated with that specific tag ID.

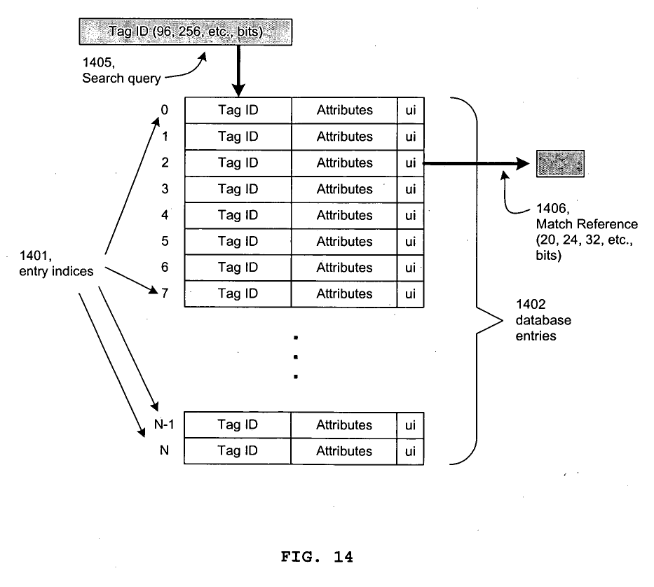

Because the tag ID is potentially quite long, (i.e., 256 bits or more) the search algorithm implements a content field lookup over some number of possible entries, with the result being a reference (index, pointer, handle, address, etc.) to the matching entry. This reference is then used to access information records related to the database entry associated with the matching tag ID. FIG. 14 illustrates the lookup process; a Search query 1405 is presented to the lookup function, which then proceeds to find a matching Tag ID; if a matching Tag ID exists, then its corresponding Match Reference 1406 is reported. If the query doesn't match any known entries, a new entry is conditionally created and a reference to the new handle is reported. One of the Tag ID Attributes is a valid flag to indicate that the entry is currently valid; when a Tag ID is eventually vacated from the database, its valid flag is set to “invalid”. This class of searching and matching algorithms is well known to those skilled in the art of computer algorithms, caching algorithms and network routing systems.

Another optional function of the System Database 1221 is to implement a replacement policy for database entries; for example, so tag IDs that have gone missing for a while may be processed for removal. The System Database may also implement time dependent attributes on database entries and implement alert mechanisms. This requires additional Attribute fields indicating time relevant information, such as the last time stamp where a given Tag ID was received. Entries that are older than a programmable threshold (also a per entry Attribute) are presented to the Notification Engine 1213 and optionally Conditioning Engine 1212 for processing. An example notification for an aged out entry would be the difference message “ID removed”. The Messaging Engine 1214 would be employed at this point to construct a “tag referenced”, “index referenced” or other formatted message; this message can either be a stand alone data frame or consolidated with other data frames.

The Task Queue Engine 1222 provides the mechanism for scheduling and coordinating the flow of data and tasks through the system. This function can be implemented as a centralized system resource, as shown in FIG. 12, or distributed as a thread intercommunication mechanism that relies on a system thread scheduler.

The Messaging Engine 1214 implements the interface structures and schemas for conveying data to a client application such as an upstream Data Aggregation Gateway, middleware application, or data processing application. Any such upstream application will probably maintain its own retained database of tag data; in certain implementations, it may be advantageous for the Messaging Engine 1214 to construct update messages that are incremental and faster to process by an upstream application. For example, sending an agreed upon index (index referenced) rather than a full tag ID is one example that saves the upstream application the workload of conducting a lookup search. This invention contemplates this and other incremental database techniques known to those skilled in the art of high performance database design.

The Protocol Engine 1215 constructs the message formed by the Messaging Engine 1214 into data packets suitable for egress on the selected interface protocol. An example interface protocol is TCP/IP over Ethernet or TCP/IP over T1 with Frame Relay.

The inter-process communication subsystem 1223 provides the mechanism for allowing the constituent processing engines to communicate. Examples of inter-process communication include shared memory segments, socket streams, message queues, etc.

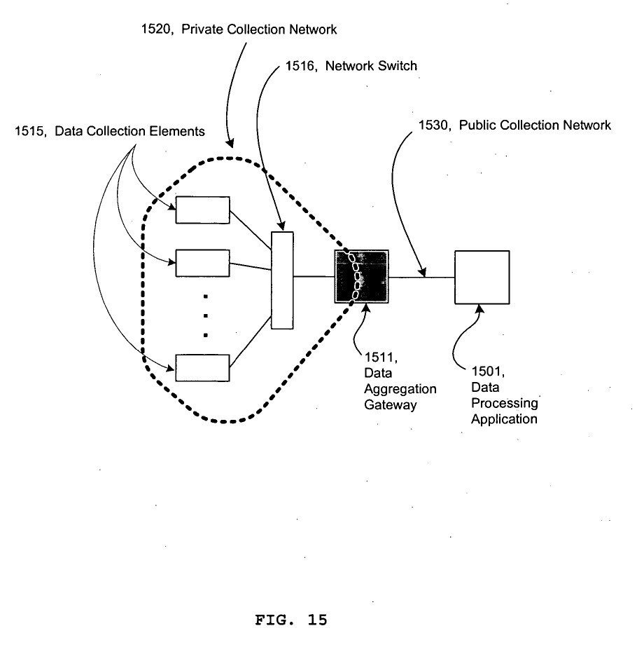

FIG. 15 illustrates the data proxy function of the Data Aggregation Gateway. A Private Collection Network 1520 is formed on the Data Collection Element 1515 side of the Data Aggregation Gateway 1511. Each Data Collection Element 1515 sends data to the Data Aggregation Gateway 1511 via an optional Network Switch 1516; note that a hub or bridge may be used in place of this switch. In alternate embodiments of this invention, the Data Aggregation Gateway 1511 subsumes the function of the Network Switch 1516. The Data Aggregation Gateway 1511 consolidates the Private Collection Network 1520 data into a Public Collection Network 1530 view of that data to be presented upstream to a Data Processing Application 1501. The Data Aggregation Gateway 1511 provides a demarcation point between independent downstream elements and an aggregated upstream view of those elements. The downstream elements are thus encapsulated in a unified view provided by the Data Aggregation Gateway, which retains all the relevant state of each Data Collection Element and avails this state to upstream Data Aggregation Gateways or Data Processing Applications 1501.

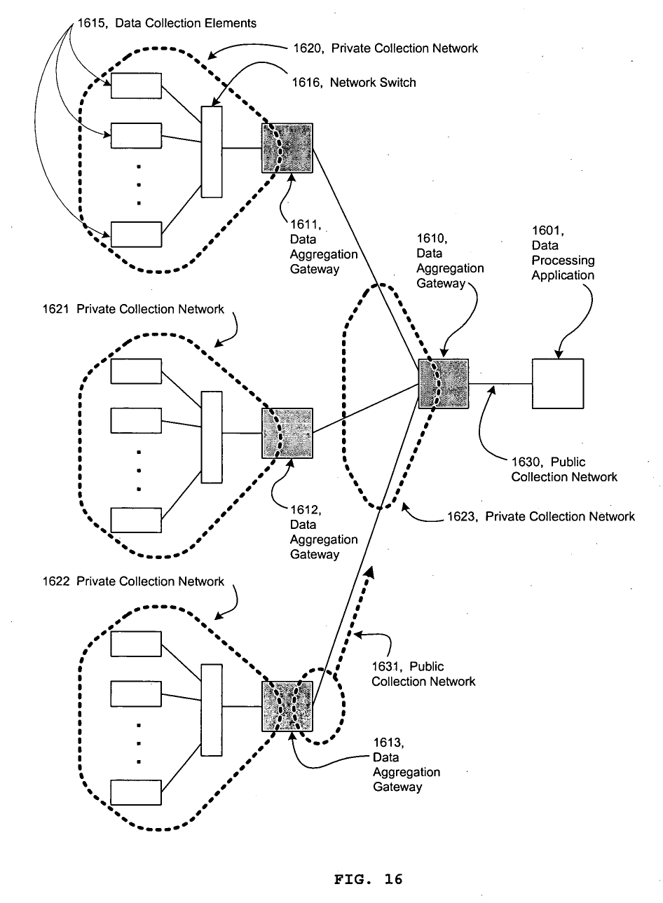

This demarcation mechanism can be used in a hierarchy of Data Aggregation Gateways as shown in FIG. 16. A collection of one or more Data Collection Elements 1615 is encapsulated by one Data Aggregation Gateway 1611 1612 1613. Each Data Aggregation Gateway forms a Private Collection Network 1620 1621 1622 with its readers, presenting a Public Collection Network upstream 1631. An upstream Data Aggregation Gateway 1610 then encapsulates these Public Collection Networks into a Private Collection Network and one upstream Public Collection Network 1630. At each stage, a Data Aggregation Gateway provides a proxy to underlying Data Aggregation Gateways or Data Collection Elements. The Data Collection Element facing network is considered Private because private configuration state and data are managed on that network; each upstream facing network is considered Public because underlying Private networks are combined into a well known, consistent, unified public interface to the underlying data. A combination of Data Aggregation Gateways and network infrastructure will be referred to as a Data Proxy Network.

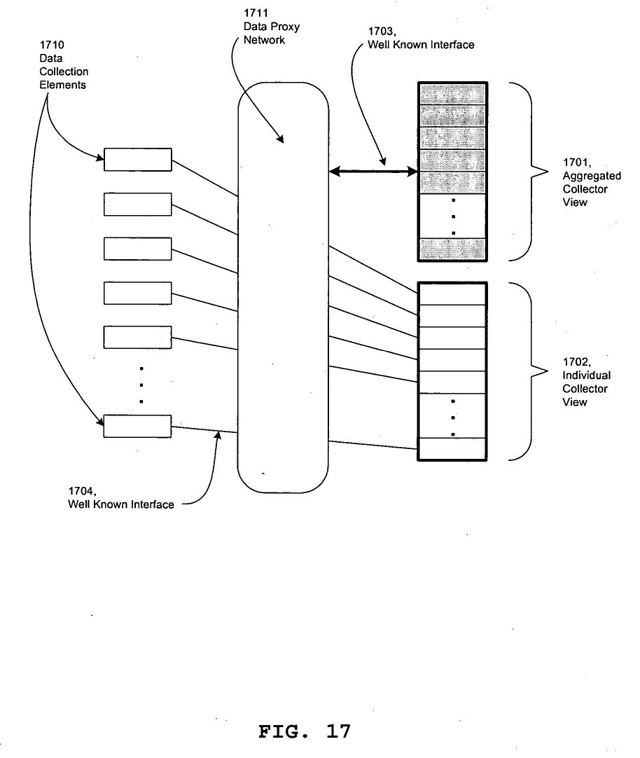

FIG. 17 illustrates the outward facing view of a Data Proxy Network. The Data Collection Elements 1710 may be RFID readers, for example. The Data Proxy Network 1711 may be a collection of one or more Data Aggregation Gateways and zero or more network switches.

The Data Aggregation Gateway that gathers all underlying state and data presents two views of the underlying data in the Data Proxy Network 1711. The first view, the Aggregated Collector View 1701 is a well-known interface (typically a port number and protocol in TCP/IP) that aggregates all of the underlying readers and preferably matches the Well Known Interface 1704 associated with the readers. In this way, the farthest upstream Data Aggregation Gateway presents itself to an upstream application as though it were a reader with a potentially very large coverage footprint with a large number of tag IDs under management. This farthest upstream Data Aggregation Gateway retains the data reported by all underlying systems and turns around all requests without the need to generate additional reader traffic.

The second view, the Individual Collector View 1702 provides individual access to the readers and intermediary elements in the Data Proxy Network 1711. An exemplary method by which upstream servers can identify, configure and access individual readers is Port Address Translation (PAT). PAT is a technique known to those skilled in the art of networking and network protocols.

By providing both an Aggregated Collector View 1701 and an Individual Collector View 1702, the Data Aggregation Gateway provides a single, well known interface as well as the option of management and control of individual readers.

In addition to providing an Aggregated Collector View 1701 that is compatible with the native format of an individual reader, this invention also contemplates an Aggregated Collector View provided by a Data Aggregation Gateway containing additional Attribute Data. This Attribute Data may include, without limitation, reader identification (for example, IP number) associated with a given reported tag ID, signal strength between reader and tag, ambient noise information per reader and other reader system status information.

Thus, in addition to providing ID tag data and device aggregation services, the Data Aggregation Gateway optionally provides individual device management and monitoring, with a consolidated proxy presentation of all underlying data and status associated with all systems under Data Aggregation Gateway management.

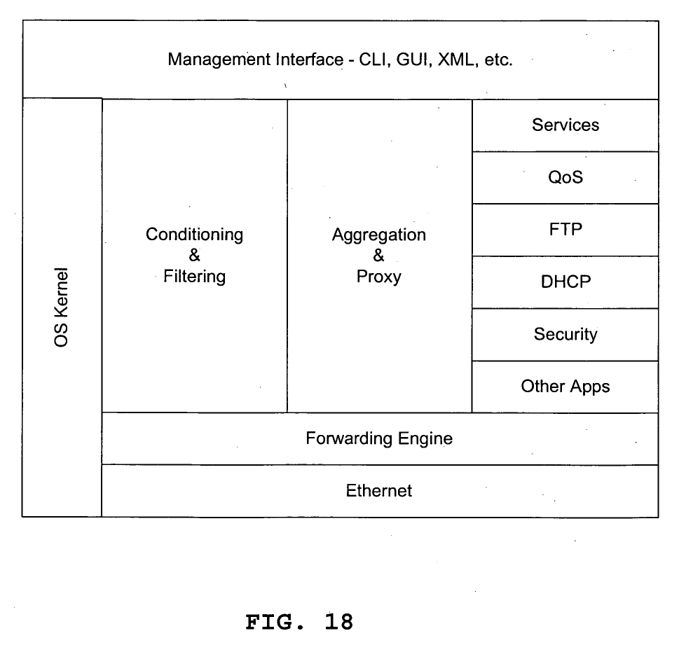

FIG. 18 illustrates the overall software architecture of an exemplary Data Aggregation Gateway. Note that many of the customary operating system services may be provided by the Data Aggregation Gateway, with unique distinguishing features provided by the Conditioning & Filtering Engines, the Aggregation and Proxy Engines and the Forwarding Engine.

Although the above has been generally described in terms of object level tagging of movable objects, there can be many other variations, modifications, and alternatives. For example, the invention can be applied other applications including almost any system of autonomous intercommunicating devices. Examples of such systems include not only EPC and UPC data collections, but also, without limitation, sensor networks, “smart dust” networks, ad hoc networks and other data collection or ID reader systems, any combination of these, and the like. Of course, one of ordinary skill in the art would recognize other variations, modifications, and alternatives.

What is claimed is:

1. A method for managing a plurality of objects using RFID tags in a real-time environment, the method comprising:
transferring information in a first format from one or more RFID tags using an RFID network, the one or more RFID tags being coupled to respective objects, each of the objects being capable of movement by a human user;
capturing information in the first format using one or more RFID readers provided at one or more predetermined spatial region using the RFID network;
parsing the information in the first format into a second format;
processing the information in the second format using one or more processing rules to identify if the one or more RFID tags at a time period of T1 is associated with the one or more RFID tags at a time period of T2;
transferring a portion of the information from the RFID network to an enterprise network;
receiving the portion of the information at an enterprise resource planning process using the enterprise network;
determining if the one or more respective objects is physically present at a determined spatial location or not present at the determined spatial location at the time period T2.

2. The method of claim 1 wherein the one or more respective objects is associated with retail merchandise.

3. The method of claim 1 wherein the predetermined spatial region is mobile or fixed.

4. The method of claim 1 wherein the predetermined spatial region is a portion of a building or other physical entity.

5. The method of claim 1 wherein each of the objects is capable of movement by a robotic entity.

6. The method of claim 1 wherein the human user is assisted with a robotic entity.

7. The method of claim 1 wherein the RFID network comprising a wireless portion.

8. The method of claim 1 wherein the RFID network comprising a wireless portion and a wired portion.

9. The method of claim 1 wherein the first format comprises a header and a payload.

10. The method of claim 1 wherein the transferring from the one or more RFID tags comprising a broadcasting process.

11. A method for processing RFID traffic between a first network and a second network, the method comprising:
transferring information associated with a plurality of RFID tags corresponding to respective plurality of objects in a first format through an RFID network;
processing the information in the first format using one or more rules to identify one or more attributes in a portion of the information in the first format, the one or more attributes in the portion of the information being associated with at least one of the plurality of RFID tags;
processing the portion of the information in the first format associated with the change into information in a second format to be transferred from the RFID network;
transferring the portion of the information in the second format through an enterprise network; and
dropping other information in the first format from being transferred through the enterprise network.

12. The method of claim 11 wherein the portion of the information in the first format is on the order of about at least 1/500th of the portion of the information in the first format.

13. The method of claim 11 wherein the processing of the information and the processing of the portion of the information is provided using a gateway process.

14. The method of claim 11 wherein the RFID network is characterized by a data load of about 100 times a data load of the enterprise network.

15. The method of claim 11 wherein the enterprise network comprises a legacy network.

16. The method of claim 11 wherein the dropping of the other information ceases transfer of the information in the first format from being transferred to the enterprise network.

17. The method of claim 11 wherein the dropping of the other information ceases transfer of the information in the first format from being transferred to the enterprise network, whereupon the dropping reduces a quantity of information to the enterprise network from a first level to a second level in order to reduce a level of congestion of traffic through the enterprise network.

18. A system for managing RFID devices operably disposed in a pre-selected geographic region, the system comprising:
at least 3 RFID readers, each of the RFID readers being spatially disposed in selected determined regions of a physical space;
an RFID network coupled to each of the RFID readers;
an RFID gateway coupled to the RFID network, the RFID gateway being adapted to process information in at least a link layer and a network layer of the RFID network from the at least 3 RFID readers;
an enterprise network coupled to the RFID gateway; and
an ERP management process coupled to the enterprise network and coupled to the RFID gateway.

19. The system of claim 18 wherein the RFID gateway is also adapted to process information in at least a transport layer of the RFID network from the at least 3 RFID readers.

20. The system of claim 18 wherein the RFID network comprises a wired portion and a wireless portion.

21. The system of claim 18 wherein the RFID gateway comprises a conditioning process.

22. The system of claim 18 wherein the RFID gateway is adapted to aggregate information from the RFID readers.

23. The system of claim 18 wherein the RFID gateway is adapted to be a proxy of the plurality of rf reading devices for the ERP management process.

24. The system of claim 18 wherein the RFID gateway is adapted to be a data proxy for information from the plurality of RFID readers for the enterprise network.

25. The system of claim 18 wherein the RFID gateway is characterized as a demarcation point between one or more independent downstream elements and an aggregated upstream view of the one or more independent downstream elements.

26. The system of claim 25 wherein the one or more downstream elements comprising an encapsulation for a unified view.

27. The system of claim 18 wherein the RFID gateway is representative of a single point of access to all the rf reading devices.

28. The system of claim 27 wherein the RFID gateway comprises a common interface.

29. The system of claim 18 wherein the RFID gateway is representative of an aggregated view of any and all information derived from the plurality of rf reading devices.

30. The system of claim 18 wherein the RFID gateway is provided with a low latency access to the plurality of rf reading devices.

31. The system of claim 18 wherein the RFID gateway is provided to cause a reduction to a portion of downstream network traffic due to one or more requests from an upstream network traffic.

32. The system of claim 18 wherein RFID gateway is provided to retain information associated with a relevant state for each of the rf reading devices.
